(19) United States
(12) Patent Application Publication
(10) Pub. No.: US 2022/0186992 A1
(43) Pub. Date: Jun. 16, 2022

(54) A HEATING, VENTILATION, AIR CONDITIONING AND/OR REFRIGERATION SYSTEM WITH A COMPRESSOR MOTOR COOLING SYSTEM

(71) Applicant: Johnson Controls Tyco IP Holdings LLP, Miwaukee, WI (US)

(72) Inventors: Ivan Jadric, York, PA (US); Ajit Wasant Kane, York, PA (US); Jeb William Schreiber, Stewartstown, PA (US); Matthew Lee Heisey, York, PA (US); Jay Albert Kohler, York, PA (US)

(21) Appl. No.: 17/598,813

(22) PCT Filed: Mar. 27, 2020
(86) PCT No.: PCT/US2020/025240

§ 371 Date: Sep. 27, 2021

Related U.S. Application Data
(60) Provisional application No. 62/825,567, filed on Mar. 28, 2019.

(51) Int. Cl. F25B 31/00; F25B 25/00; F25B 41/39; F25B 49/02

(52) U.S. Cl. CPC F25B 31/006; F25B 25/005; F25B 41/39; F25B 49/025; F25B 2700/21156; F25B 2339/047; F25B 2400/23; F25B 2500/08; F25B 2600/2515; F25B 2339/0242

(57) ABSTRACT

A heating, ventilation, air conditioning, and/or refrigeration (HVAC&R) system includes a refrigerant loop having a compressor configured to circulate a refrigerant therethrough, a motor configured to drive rotation of the compressor, wherein the motor is a permanent magnet assisted synchronous reluctance (PMASR) motor, and a motor cooling system configured to direct a portion of the refrigerant from the refrigerant loop and through a housing of the PMASR motor to place the portion of the refrigerant in thermal communication with components of the PMASR motor.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Heating, ventilation, air conditioning, and/or refrigeration (HVAC&R) systems are used in a variety of settings and for many purposes. For example, HVAC&R systems may include a vapor compression refrigeration cycle (e.g., a refrigerant circuit having a condenser, an evaporator, a compressor, and/or an expansion device) configured to condition an environment. The vapor compression refrigeration cycle may include a compressor configured to circulate a refrigerant though components of the vapor compression refrigeration cycle. The compressor is driven by a motor, which is typically sized based on a capacity of the HVAC&R system. Unfortunately, motors of existing HVAC&R systems may achieve relatively low efficiencies when the HVAC&R system operates under low capacity conditions.

### SUMMARY

In an embodiment of the present disclosure, a heating, ventilation, air conditioning, and/or refrigeration (HVAC&R) system includes a refrigerant loop having a compressor configured to circulate a refrigerant therethrough, a motor configured to drive rotation of the compressor, wherein the motor is a permanent magnet assisted synchronous reluctance (PMASR) motor, and a motor cooling system configured to direct a portion of the refrigerant from the refrigerant loop and through a housing of the PMASR motor to place the portion of the refrigerant in thermal communication with components of the PMASR motor.

In another embodiment, a heating, ventilation, air conditioning, and/or refrigeration (HVAC&R) system includes a motor configured to drive rotation of a compressor disposed along a refrigerant loop, where the motor is a permanent magnet assisted synchronous reluctance (PMASR) motor, and the motor includes a housing, a rotor disposed within the housing, and magnets embedded within a body of the rotor. The HVAC&R system further includes a motor cooling system configured to direct a portion of refrigerant from the refrigerant loop and through the housing of the PMASR motor to place the portion of the refrigerant in thermal communication with components of the PMASR motor.

In a further embodiment of the present disclosure, a chiller system includes a refrigerant loop having a compressor configured to circulate a refrigerant therethrough and a motor configured to drive rotation of the compressor, where the motor is a permanent magnet assisted synchronous reluctance (PMASR) motor having a rotor and ferrite magnets embedded within a body of the rotor. The chiller system further includes a motor cooling system configured to direct a portion of the refrigerant from the refrigerant loop, through a housing of the PMASR motor to place the portion of the refrigerant in thermal communication with components of the PMASR motor, and back to the refrigerant loop.

### DRAWINGS

FIG. 1 is a perspective view of a building that may utilize an embodiment of a heating, ventilation, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic diagram of an embodiment of a vapor compression system, in accordance with an aspect of the present disclosure;

FIG. 4 is a schematic diagram of another embodiment of a vapor compression system, in accordance with an aspect of the present disclosure;

FIG. 5 is a schematic diagram of an embodiment of a vapor compression system having a motor for driving operation of a compressor and a motor cooling system, in accordance with an aspect of the present disclosure; and

FIG. 6 is a schematic diagram of an embodiment of a motor of the vapor compression system having a rotor and magnets coupled to the rotor, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As discussed above, heating, ventilation, air conditioning, and/or refrigeration (HVAC&R) systems may include a compressor that is configured to circulate refrigerant through a refrigerant loop having various components (e.g., a condenser, an evaporator, an expansion device, etc.). The compressor is driven by a motor that is typically selected based on a target operating capacity of the HVAC&R system (e.g., a total cooling capacity). Specifically, the motor is sized to include an operating range of speed and torque values that are configured to achieve the target operating capacity of the HVAC&R system. In some cases, the motor may operate with a reduced efficiency under relatively low load conditions of the HVAC&R system (e.g., when a load demand of the HVAC&R system is less than 50 percent of the target operating capacity of the HVAC&R system). As such, an overall efficiency of the HVAC&R system may be reduced at the relatively low load conditions.

Embodiments of the present disclosure are directed to an improved HVAC&R system (e.g., a chiller system) that includes a motor configured to operate with an enhanced efficiency across a range of operating capacities of the HVAC&R system (e.g., between 25 percent and 100 percent of the target operating capacity of the HVAC&R system). For example, the compressor of an HVAC&R system may be driven by a permanent magnet motor, and more specifically, a permanent magnet assisted synchronous reluctance (PMASR) motor. The PMASR motor may include magnets disposed on or embedded into a rotor that enable the PMASR motor to generate additional torque. In some embodiments, the PMASR motor includes ferrite magnets embedded into the rotor of the PMASR motor. The ferrite magnets are generally less expensive than rare-earth magnets that may be utilized in some PMASR motors. As such, including ferrite magnets with the PMASR motor may lower costs of the HVAC&R system. Additionally, embedding the ferrite magnets into the rotor may eliminate a retention sleeve that is typically included in motors having magnets coupled to an external surface of the rotor and that is configured to retain or hold the magnets against the external surface of the rotor at relatively high rotational speeds of the rotor.

Moreover, elimination of the retention sleeve may facilitate cooling of the motor that may be performed by routing a portion of refrigerant from the refrigerant loop through a casing or housing of the motor. As set forth below, a motor cooling system may be employed to provide cooling to the PMASR motor to remove heat or thermal energy generated as the rotor of the motor rotates to ultimately drive the compressor to compress refrigerant. For example, the motor cooling system may draw at least a portion of the refrigerant exiting a condenser of the refrigerant loop and direct the portion of refrigerant through the PMASR, such that the portion of refrigerant absorbs thermal energy from components within the PMASR (e.g., the stator windings, the rotor, and/or other suitable components). Accordingly, the efficiency of the HVAC&R system may be improved further by operating the motor at a lower temperature by removing thermal energy generated within the motor that may otherwise affect a performance of the motor. Utilization of PMASR motors has typically been avoided in existing HVAC&R systems because of the relatively high costs of such motors. Embodiments of the present disclosure recognize that the added costs of the PMASR motor may be outweighed by the increased efficiency achieved at relatively low operating capacities of the HVAC&R system (e.g., less than 50 percent of the total operating capacity). Further, implementation of a motor cooling system may further increase an efficiency of the PMASR motor, which may reduce operating costs of the HVAC&R system.

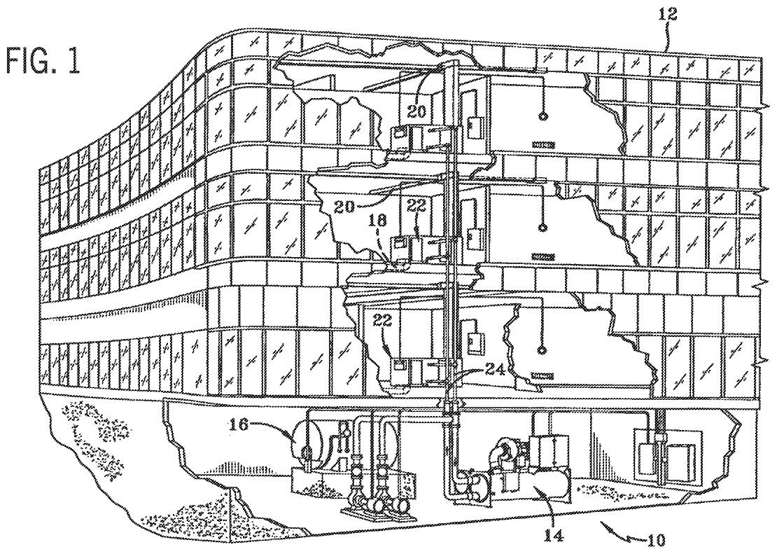

Turning now to the drawings, FIG. 1 is a perspective view of an embodiment of an environment for a heating, ventilation, air conditioning, and/or refrigeration (HVAC&R) system 10 in a building 12 for a typical commercial setting. The HVAC&R system 10 may include a vapor compression system 14 that supplies a chilled liquid, which may be used to cool the building 12. The HVAC&R system 10 may also include a boiler 16 to supply warm liquid to heat the building 12 and an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or chilled liquid from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

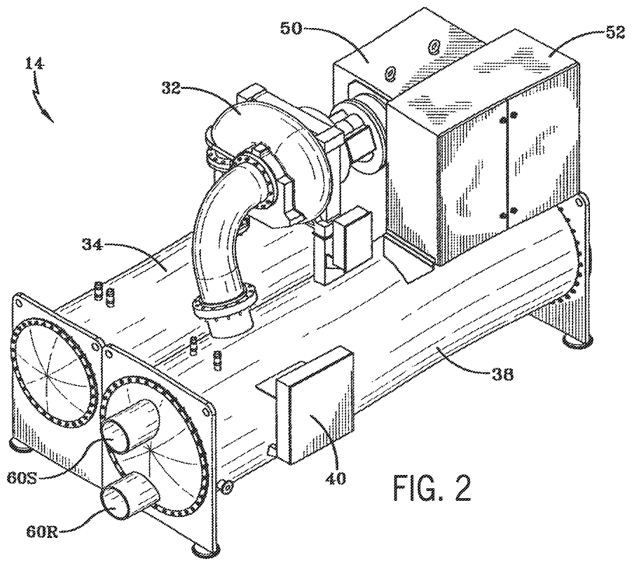

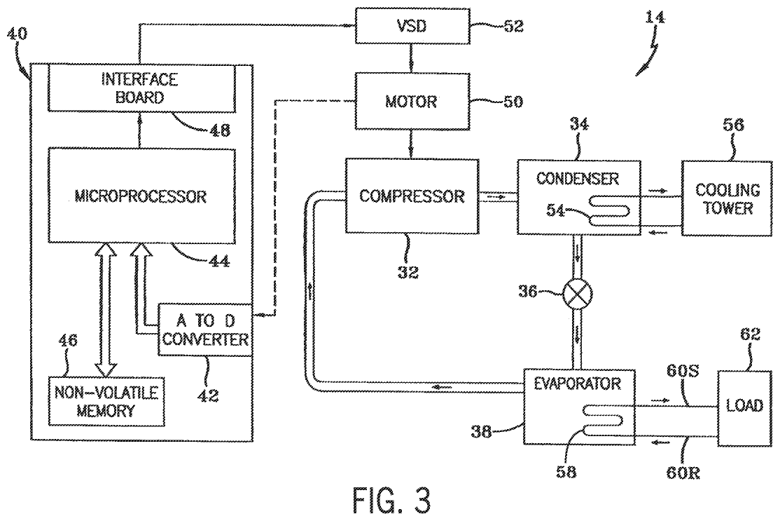

FIGS. 2 and 3 illustrate embodiments of the vapor compression system 14 that can be used in the HVAC&R system 10. The vapor compression system 14 may circulate a refrigerant through a circuit starting with a compressor 32. The circuit may also include a condenser 34, an expansion valve(s) or device(s) 36, and a liquid chiller or an evaporator 38. The vapor compression system 14 may further include a control panel 40 (e.g., a controller) that has an analog to digital (A/D) converter 42, a microprocessor 44, a non-volatile memory 46, and/or an interface board 48.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 and may be powered by a variable speed drive (VSD) 52. The VSD 52 receives alternating current (AC) power having a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a refrigerant vapor and delivers the vapor to the condenser 34 through a discharge passage. In some embodiments, the compressor 32 may be a centrifugal compressor. The compressor 32 includes a fluid (e.g., oil) that lubricates components of the compressor. In other embodiments, the compressor 32 may be oil-free and utilize magnetic bearings. The refrigerant vapor delivered by the compressor 32 to the condenser 34 may transfer heat to a cooling fluid (e.g., water or air) in the condenser 34. The refrigerant vapor may condense to a refrigerant liquid in the condenser 34 as a result of thermal heat transfer with the cooling fluid. The refrigerant liquid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser.

The refrigerant liquid delivered to the evaporator 38 may absorb heat from another cooling fluid, which may or may not be the same cooling fluid used in the condenser 34. The refrigerant liquid in the evaporator 38 may undergo a phase change from the refrigerant liquid to a refrigerant vapor. As shown in the illustrated embodiment of FIG. 3, the evaporator 38 may include a tube bundle 58 having a supply line 60S and a return line 60R connected to a cooling load 62. The cooling fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the cooling fluid in the tube bundle 58 via thermal heat transfer with the refrigerant. The tube bundle 58 in the evaporator 38 can include a plurality of tubes and/or a plurality of tube bundles. In any case, the refrigerant vapor exits the evaporator 38 and returns to the compressor 32 by a suction line to complete the cycle.

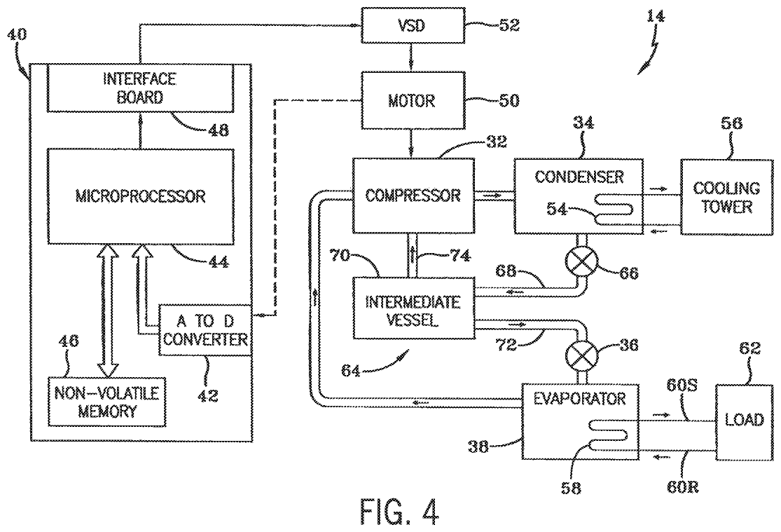

FIG. 4 is a schematic diagram of the vapor compression system 14 with an intermediate circuit 64 incorporated between condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the refrigerant liquid received from the condenser 34. During the expansion process, a portion of the liquid may vaporize, and thus, the intermediate vessel 70 may be used to separate the vapor from the liquid received from the first expansion device 66. Additionally, the intermediate vessel 70 may provide for further expansion of the refrigerant liquid because of a pressure drop experienced by the refrigerant liquid when entering the intermediate vessel 70 (e.g., due to a rapid increase in volume experienced when entering the intermediate vessel 70). The vapor in the intermediate vessel 70 may be drawn by the compressor 32 through a suction line 74 of the compressor 32. In other embodiments, the vapor in the intermediate vessel may be drawn to an intermediate stage of the compressor 32 (e.g., not the suction stage). The liquid that collects in the intermediate vessel 70 may be at a lower enthalpy than the refrigerant liquid exiting the condenser 34 because of the expansion in the expansion device 66 and/or the intermediate vessel 70. The liquid from intermediate vessel 70 may then flow in line 72 through a second expansion device 36 to the evaporator 38.

As discussed above, embodiments of the present disclosure are directed to an HVAC&R system, such as the HVAC&R system 10 having the vapor compression system 14, that includes a permanent magnet assisted synchronous reluctance (PMASR) motor. The PMASR motor may increase an efficiency of the HVAC&R system 10 by generating increased torque (e.g., per amount of electrical power consumed by the PMASR motor) applied to a compressor, such as the compressor 32, of the HVAC&R system. More specifically, the PMASR motor may generate fewer losses (e.g., magnet losses, rotor losses, stator losses, winding losses, or other losses) at both full operating capacity conditions and relatively low operating capacities conditions of the HVAC&R system, such that an efficiency of the HVAC&R system is improved across a wide range of operating capacities. As set forth above, the PMASR motor may include magnets (e.g., ferrite magnets) embedded or molded into a rotor of the PMASR motor. The magnets may generate additional torque during operation of the PMASR motor, which may enable the PMASR motor to supply a sufficient amount of power to the compressor over a wide range of operating capacities of the HVAC&R system. Further still, the HVAC&R system may include a motor cooling system that removes thermal energy generated within a housing of the PMASR motor during operation. Additional thermal energy may be removed from the PMASR motor as a result of elimination of a retention sleeve that is typically included when magnets are disposed on an external surface of the rotor (e.g., to retain or hold magnets against the rotor at relatively high rotational speeds of the rotor).

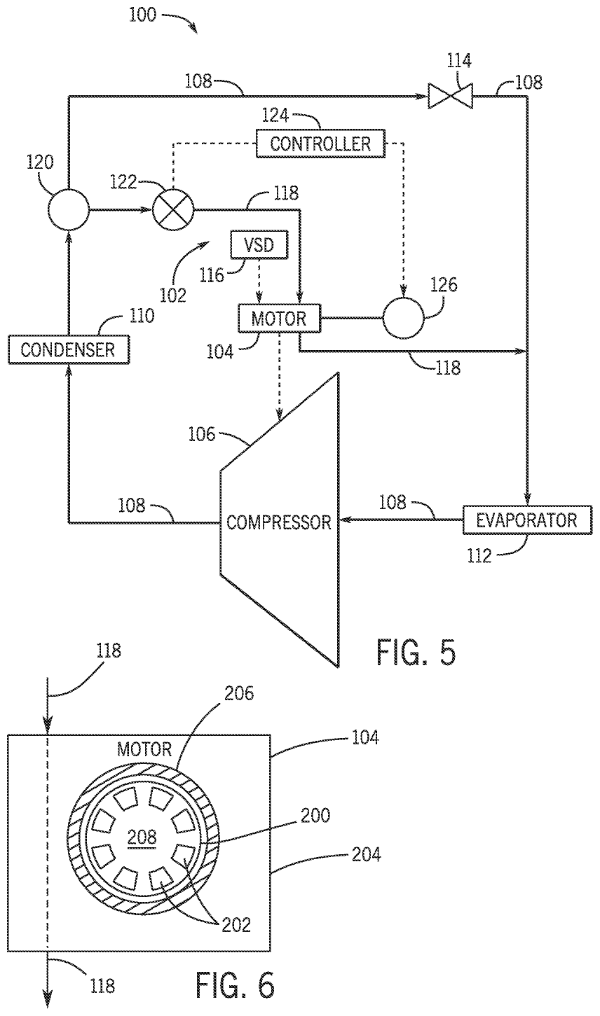

FIG. 5 is a schematic diagram of an HVAC&R system 100, such as a chiller system, having a motor cooling system 102 configured to remove thermal energy from a PMASR motor 104 that drives a compressor 106, such as the compressor 32, of the HVAC&R system 100. The PMASR motor 104 may be coupled to the compressor 106 via a shaft that transfers rotational forces of the PMASR motor 104 to components within the compressor 106 (e.g., an impeller). The compressor 106 is thus configured to pressurize refrigerant (e.g., R-134a, R-513A, R-123, R-1233zd, and/or R-514A) within a refrigerant loop 108 of the HVAC&R system 100 to circulate the refrigerant through a condenser 110 (e.g., the condenser 34), an evaporator 112 (e.g., the evaporator 38), and/or an expansion device 114 (e.g., the expansion device 36) disposed along the refrigerant loop 108. The refrigerant may thus undergo phase changes via thermal energy transfer with a cooling fluid flowing through the condenser 110 and/or a working fluid flowing through the evaporator 112.

The PMASR motor 104 may generate torque as a result of a shape of a rotor 200 of the PMASR motor 104 (e.g., projections on the rotor 200 that act as preferred magnetic axes and generate reluctance torque via interactions with magnetic fields generated by windings 206 of a stator) as well as from magnets 202 that are embedded within, or otherwise coupled to, the rotor 200 (e.g., the magnets 202 generate additional torque via interactions with the magnetic fields generated by the windings 206 of the stator). For example, FIG. 6 is a schematic of the PMASR motor 104, illustrating the rotor 200 having the magnets 202 and the windings 206 of the stator disposed about the rotor 200. As should be understood, rotation of the rotor 200 of the PMASR motor 104 is driven as a result of magnetic fields generated as electrical energy is supplied to stator windings 206 of the PMASR motor 104. The magnetic fields may convert the electrical energy to mechanical energy (e.g., rotational energy) that ultimately drives rotation of the rotor 200. In some embodiments, the rotor 200 of the PMASR motor 104 may include a 4-pole configuration, i.e., four magnetic poles disposed on or coupled to the rotor 200. In other embodiments, the PMASR motor 104 may include a 2-pole configuration and/or another suitable configuration for generating a force suitable for achieving a target operating capacity of the HVAC&R system 100.

Further, the rotor 200 of the PMASR motor 104 includes magnets 202 that may be imbedded or molded within a body 208 of the rotor 200 to generate additional torque. For example, the magnets 202 may be configured to interact with a flux barrier disposed within a casing of the PMASR motor 104 to further generate magnetic torque for driving rotation of the rotor 200. In some embodiments, the magnets 202 include ferrite magnets embedded within a body 208 of the rotor 200. In other embodiments, the magnets 202 include rare-earth magnets, such as neodymium magnets, Alnico magnets, Samarium Cobalt magnets, or other suitable magnets.

In some embodiments, the rotor 200 of the PMASR motor 104 includes a length that is between 100 millimeters (mm) and 200 mm, between 150 and 175 mm, or between 160 mm and 170 mm. For instance, the rotor 200 of the PMASR motor 104 may include a length of approximately 170 mm. In other embodiments, the rotor 200 of the PMASR motor 104 may include any suitable length based on the target operating capacity of the HVAC&R system 100.

As set forth above, a variable speed drive (VSD) 116 may be configured to supply electrical energy to the PMASR motor 104 to vary a speed (e.g., rotational speed) of the PMASR motor 104, and thus, a speed of the compressor 106. For instance, the VSD 116 receives alternating current (AC) power having a particular fixed line voltage and fixed line frequency from an AC power source and provides power having a variable voltage and frequency to the PMASR motor 104. For example, in some embodiments, the VSD 116 may include a switching frequency of between 0.9 and 1.2. More specifically, the VSD 116 may include a switching frequency of approximately 5000 Hertz (HZ) or approximately 5500 Hz.

In any case, the PMASR motor 104 may enhance an efficiency of the HVAC&R system 100, particularly at relatively low operating capacities of the HVAC&R system 100 (e.g., below 50 percent of a total operating capacity of the HVAC&R system 100). For example, the PMASR motor 104 may increase an amount of torque that is ultimately supplied to the compressor 106, while incurring fewer losses when compared to traditional motors used for HVAC&R systems. Further, winding losses occurring from thermal energy generation within the motor 104 may be reduced via the motor cooling system 102 that removes thermal energy from within a housing 204 of the PMASR motor 104 using refrigerant from the refrigerant loop 108.

As shown in the illustrated embodiment of FIG. 5, a portion of the refrigerant exiting the condenser 110 may be diverted to a motor cooling loop 118 via a tee 120 (e.g., a first tee and/or a first three-way valve). A valve 122 (e.g., a ball valve, a butterfly valve, a gate valve, a globe valve, a diaphragm valve, and/or another suitable valve) may be disposed along the motor cooling loop 118 downstream of the tee 120 with respect to the flow of the refrigerant through the motor cooling loop 118. The valve 122 may be configured to adjust an amount (e.g., a flow or flow rate) of the refrigerant that is diverted into the motor cooling loop 118 from the refrigerant loop 108. In some embodiments, the valve 122 is coupled to a controller 124, which may adjust a position of the valve 122 to control a flow or flow rate of the refrigerant through the motor cooling loop 118 based on a temperature of the PMASR motor 104 monitored by a sensor 126 (e.g., temperature sensor), for example. The refrigerant flowing through the motor cooling loop 118 is directed into the housing 204 of the PMASR motor 104 to place the refrigerant in a heat exchange relationship with a component (e.g., a stator, the rotor 200, and/or bearings) of the PMASR motor 104. Accordingly, the refrigerant absorbs thermal energy (e.g., heat) from the PMASR motor 104 to reduce a temperature of the PMASR motor 104. The refrigerant is then directed from the PMASR motor 104 back toward the refrigerant loop 108, where the refrigerant may flow into the evaporator 112.

As set forth above, the PMASR motor 104 includes magnets 202 embedded within the rotor 200 (e.g., within the body 208 of the rotor 200), such that a retention sleeve may be eliminated from the PMASR motor 104 (e.g., the retention sleeve is generally included when magnets are disposed on an external surface of the rotor and not embedded within the rotor). It is now recognized that the retention sleeve may reduce an amount of thermal energy transfer between the components of the PMASR motor 104 and the refrigerant circulated through the motor cooling loop 118. As such, embedding the magnets 202 within the body 208 of the rotor 200 of the PMASR motor 104 may increase an amount of thermal energy transfer between the PMASR motor 104 and refrigerant circulated through the motor cooling loop 118 and within the housing 204 of the PMASR motor 104, which may further increase an efficiency of the PMASR motor 104. Moreover, elimination of the retention sleeve may enable the PMASR motor 104 to operate at higher temperatures when compared to motors with a retention sleeve, without substantially affecting a performance of the PMASR motor 104. Thus, the motor cooling system 102, in addition to utilizing the PMASR motor 104 (e.g., with the magnets 202 embedded in the rotor 200), may increase an efficiency of the HVAC&R system 100 over a wide range of operating capacities of the HVAC&R system 100.

Embodiments of the present disclosure may provide one or more technical effects useful in increasing an efficiency of an HVAC&R system. For example, embodiments of the present disclosure are directed to an HVAC&R system that includes a permanent magnet assisted synchronous reluctance (PMASR) motor and a motor cooling system. Utilizing the PMASR motor may increase an efficiency of the HVAC&R system under relatively low operating capacity conditions. Further, a rotor of the PMASR may include magnets embedded within a body of the rotor, which may increase an amount of torque transferred from the PMASR motor to a compressor. Additionally, embedding the magnets within the body of the rotor may eliminate the use of a retention sleeve that is generally included when magnets are disposed on an external surface of a rotor instead of embedded within the rotor. Elimination of the retention sleeve may increase an amount of thermal energy transfer between refrigerant from the motor cooling system and components (e.g., the rotor, the stator) of the PMASR motor, which may further increase an efficiency of the HVAC&R system. The technical effects and technical problems in the specification are examples and are not limiting. It should be noted that the embodiments described in the specification may have other technical effects and can solve other technical problems.

While only certain features and embodiments of the present disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the present disclosure. Furthermore, in an effort to provide a concise description of the exemplary embodiments, all features of an actual implementation may not have been described (i.e., those unrelated to the presently contemplated best mode of carrying out the present techniques, or those unrelated to enabling the claimed embodiments). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilation, air conditioning, and/or refrigeration (HVAC&R) system, comprising:
a refrigerant loop having a compressor configured to circulate a refrigerant therethrough;
a motor configured to drive rotation of the compressor, wherein the motor is a permanent magnet assisted synchronous reluctance (PMASR) motor; and
a motor cooling system configured to direct a portion of the refrigerant from the refrigerant loop and through a housing of the PMASR motor to place the portion of the refrigerant in thermal communication with components of the PMASR motor.

2. The HVAC&R system of claim 1, wherein the PMASR motor comprises a rotor having magnets embedded within a body of the rotor.

3. The HVAC&R system of claim 2, wherein the magnets are ferrite magnets.

4. The HVAC&R system of claim 2, wherein the magnets are rare-earth magnets.

5. The HVAC&R system of claim 1, comprising a variable speed drive configured to vary an amount of electrical energy supplied to the PMASR motor.

6. The HVAC&R system of claim 1, comprising a controller communicatively coupled to a valve of the motor cooling system and a sensor configured to provide feedback indicative of a temperature within the housing of the PMASR motor, wherein the controller is configured to adjust a position of the valve to control a flow of the portion of the refrigerant from the refrigerant loop and through the housing of the PMASR motor.

7. The HVAC&R system of claim 1, wherein the refrigerant loop comprises a condenser configured to place the refrigerant in thermal communication with a cooling fluid and an evaporator configured to place the refrigerant in thermal communication with a working fluid.

8. The HVAC&R system of claim 7, wherein the motor cooling system is configured to direct the portion of the refrigerant from a location along the refrigerant loop downstream of the condenser.

9. The HVAC&R system of claim 1, wherein the PMASR motor is without a retention sleeve.

10. A heating, ventilation, air conditioning, and/or refrigeration (HVAC&R) system, comprising:
a motor configured to drive rotation of a compressor disposed along a refrigerant loop, wherein the motor is a permanent magnet assisted synchronous reluctance (PMASR) motor, and the motor comprises a housing, a rotor disposed within the housing, and magnets embedded within a body of the rotor; and
a motor cooling system configured to direct a portion of refrigerant from the refrigerant loop and through the housing of the PMASR motor to place the portion of the refrigerant in thermal communication with components of the PMASR motor.

11. The HVAC&R system of claim 10, wherein the motor cooling system is configured to place the portion of the refrigerant in thermal communication with the rotor, a stator of the PMASR motor, bearings of the PMASR motor, or any combination thereof.

12. The HVAC&R system of claim 10, comprising the refrigerant loop, wherein the refrigerant loop comprises the compressor configured to pressurize the refrigerant, a condenser configured to place the refrigerant in thermal communication with a cooling fluid, and an evaporator configured to place the refrigerant in thermal communication with a working fluid.

13. The HVAC&R system of claim 12, wherein the motor cooling system is configured to direct the portion of the refrigerant from a first location along the refrigerant loop downstream of the condenser to the housing and from the housing to a second location along the refrigerant loop upstream of the evaporator.

14. The HVAC&R system of claim 10, wherein the magnets comprise ferrite magnets.

15. The HVAC&R system of claim 10, wherein the PMASR motor is without a retention sleeve disposed about the rotor.

16. The HVAC&R system of claim 10, wherein the motor cooling system comprises:
a valve configured to regulate a flow of the portion of the refrigerant directed from the refrigerant loop to the housing; and
a controller communicatively coupled to the valve, wherein the controller is configured to adjust a position of the valve to adjust the flow of the portion of the refrigerant based on feedback indicative of a temperature of the PMASR motor.

17. The HVAC&R system of claim 16, wherein the motor cooling system comprises a sensor communicatively coupled to the controller, wherein the sensor is configured to detect a temperature within the housing of the PMASR motor and to communicate the feedback to the controller.

18. A chiller system, comprising:
a refrigerant loop comprising a compressor configured to circulate a refrigerant therethrough;
a motor configured to drive rotation of the compressor, wherein the motor is a permanent magnet assisted synchronous reluctance (PMASR) motor comprising a rotor and ferrite magnets embedded within a body of the rotor; and
a motor cooling system configured to direct a portion of the refrigerant from the refrigerant loop, through a housing of the PMASR motor to place the portion of the refrigerant in thermal communication with components of the PMASR motor, and from the housing back to the refrigerant loop.

19. The HVAC&R system of claim 18, wherein the PMASR motor is without a retention sleeve disposed about the rotor.

20. The HVAC&R system of claim 19, wherein the refrigerant loop comprises a condenser configured to place the refrigerant in thermal communication with a cooling fluid and an evaporator configured to place the refrigerant in thermal communication with a working fluid,
wherein the motor cooling system is configured to direct the portion of the refrigerant from a first location along the refrigerant loop downstream of the condenser to the housing and from the housing to a second location along the refrigerant loop upstream of the evaporator; and
wherein the motor cooling system comprises:
a valve configured to regulate a flow of the portion of the refrigerant directed from the refrigerant loop to the housing;
a sensor configured to detect a temperature within the housing of the PMASR motor; and
a controller communicatively coupled to the valve and to the sensor, wherein the controller is configured to adjust a position of the valve to adjust the flow of the portion of the refrigerant based on feedback indicative of the temperature within the housing of the PMASR motor received via the sensor.
